(19) United States
(12) Patent Application Publication
(10) Pub. No.: US 2016/0378023 A1
(43) Pub. Date: Dec. 29, 2016

(54) TRANSFER DEVICE AND IMAGE FORMING APPARATUS

(71) Applicant: FUJI XEROX CO., LTD., Tokyo (JP)

(72) Inventor: Arichika TANAKA, Kanagawa (JP)

(21) Appl. No.: 14/881,951

(22) Filed: Oct. 13, 2015

(30) Foreign Application Priority Data
Jun. 29, 2015 (JP) 2015-129853

(51) Int. Cl. G03G 15/16

(52) U.S. Cl. CPC G03G 15/161

(57) ABSTRACT

A transfer device includes a belt-shaped body and at least one transfer surface forming member. At least one image held by at least one image holding body is transferred to the belt-shaped body. The belt-shaped body is moved so as to be rotated in a single direction. The at least one transfer surface forming member has an outer radius, has a central portion and one and another end portions in a direction perpendicular to a movement direction of the belt-shaped body, and forms a transfer surface so as to cause the belt-shaped body to be in contact with the at least one image holding body. The outer radius of the at least one transfer surface forming member is larger at the central portion than at the one and the other end portions.

### CROSS-REFERENCE TO RELATED APPLICATIONS

This application is based on and claims priority under 35 USC 119 from Japanese Patent Application No. 2015-129853 filed Jun. 29, 2015.

### BACKGROUND

### Technical Field

The present invention relates to a transfer device and an image forming apparatus.

### SUMMARY

According to an aspect of the present invention, a transfer device includes a belt-shaped body and at least one transfer surface forming member. At least one image held by at least one image holding body is transferred to the belt-shaped body. The belt-shaped body is moved so as to be rotated in a single direction. The at least one transfer surface forming member has an outer radius, has a central portion and one and another end portions in a direction perpendicular to a movement direction of the belt-shaped body, and forms a transfer surface so as to cause the belt-shaped body to be in contact with the at least one image holding body. The outer radius of the at least one transfer surface forming member is larger at the central portion than at the one and the other end portions.

### BRIEF DESCRIPTION OF THE DRAWINGS

Exemplary embodiment of the present invention will be described in detail based on the following figures, wherein:

FIG. 1 is a side view of an image forming apparatus according to an exemplary embodiment of the present invention;

FIG. 2 is a side view illustrating a meandering controller and a structure around the meandering controller of the image forming apparatus according to the exemplary embodiment of the present invention;

FIG. 3 is a side view of an upper half of a transfer surface forming member used in the image forming apparatus according to the exemplary embodiment of the present invention;

FIG. 4 is a chart illustrating the relationship between roller misalignment and an image density difference;

FIG. 5 is a side view of an upper half of a variation of the transfer surface forming member used in the image forming apparatus according to the exemplary embodiment of the present invention; and

FIG. 6 is a side view of an upper half of another variation of the transfer surface forming member used in the image forming apparatus according to the exemplary embodiment of the present invention.

### DETAILED DESCRIPTION

Next, an exemplary embodiment of the present invention will be described in detail with reference to the drawings.

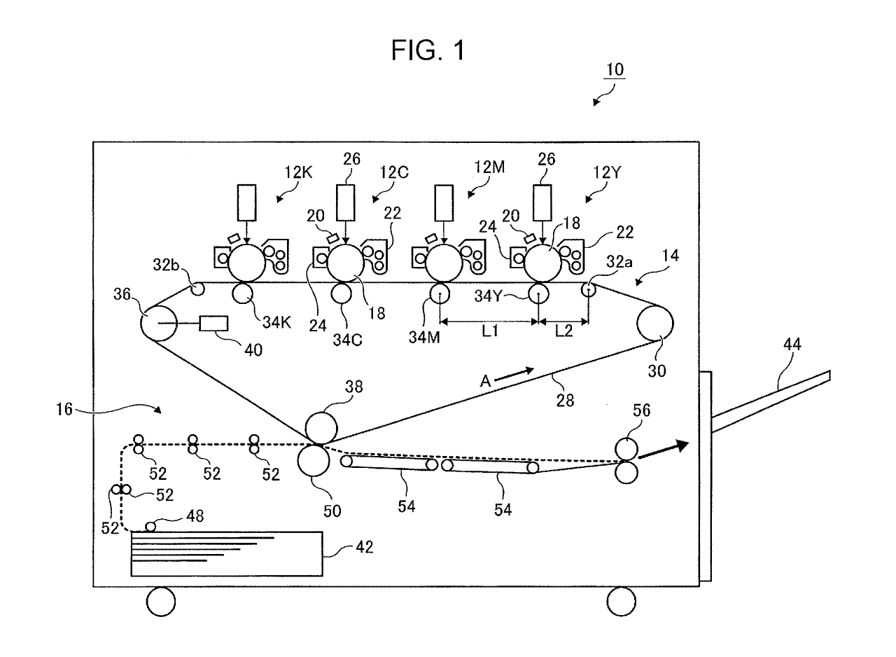

FIG. 1 illustrates the structure of an image forming apparatus 10 according to an exemplary embodiment of the present invention.

The image forming apparatus 10 includes, for example, four image forming units 12Y, 12M, 12C, and 12K, an intermediate transfer device 14, and a sheet transport device 16.

The image forming units 12Y, 12M, 12C, and 12K are spaced apart from one another by a certain distance in the horizontal direction. According to the present exemplary embodiment, the image forming units 12Y, 12M, 12C, and 12K are arranged in the order of colors yellow (Y), magenta (M), cyan (C), and black (K). However, the image forming units 12Y, 12M, 12C, and 12K may be arranged in any order of the colors such as the order of black (K), yellow (Y), magenta (M), and cyan (C).

The image forming units 12Y, 12M, 12C, and 12K each include a photosensitive drum 18, a charger 20, a developing device 22, and a clearing device 24. The charger 20 that serves as a charging device uniformly charges a surface of the photosensitive drum 18. The developing device 22 develops an electrostatic latent image formed on the photosensitive drum 18. The photosensitive drum 18 that serves as a cylindrical image holding body holds a toner image (developer image) and is uniformly charged by the charger 20. The electrostatic latent image is formed on the photosensitive drum 18 by laser light radiated by a light scanning device 26. The electrostatic latent image formed on the photosensitive drum 18 is developed with toner by the developing device 22 and transferred onto an intermediate transfer belt (belt-shaped body) 28 of the intermediate transfer device 14, which will be described later. The residual toner, paper dust, and so forth attracted to the photosensitive drum 18 after the toner image has been transferred are removed by the clearing device 24.

The intermediate transfer device 14 includes the intermediate transfer belt 28 that serves as the belt-shaped body. This intermediate transfer belt 28 is formed, for example, as follows: that is, a synthetic resin film formed of polyimide or the like having flexibility is shaped into a belt; and both ends of the belt-shaped synthetic resin film are connected to each other by, for example, welding so as to have an endless belt shape. The intermediate transfer belt 28 is rotated in an arrow A direction of FIG. 1. That is, the intermediate transfer belt 28 is looped over a drive member (drive roller) 30, first transfer surface forming members (first transfer surface forming rollers) 32a and 32b, first transfer members (first transfer rollers) 34Y, 34M, 34C, and 34K, a steering roller 36, and a backup roller 38 under a certain tension. The steering roller 36 includes a meandering controller 40 that controls meandering of the intermediate transfer belt 28.

The first transfer members 34Y, 34M, 34C, and 34K are spaced apart from one another by a certain distance L1 so as to correspond to the respective photosensitive drums 18. Furthermore, the first transfer member 34Y and the first transfer surface forming member 32a are spaced apart from each other by a distance L2, and the first transfer member 34K and the first transfer surface forming member 32b are spaced apart from each other also by the distance L2. The distance L2 is smaller than the distance L1. Thus, the length in the width direction (left-right direction of the page of the drawing) of the intermediate transfer device 14 may be reduced.

The sheet transport device 16 is disposed below the intermediate transfer device 14. The sheet transport device 16 includes a sheet transport path 46 through which a sheet of paper is transported from a sheet supply member 42 to a sheet output member 44. The sheet transport path 46 includes a feed roller 48 and plural transport rollers 52.

The feed roller 48 feeds the sheet from the sheet supply member 42. The plural transport rollers 52 transport the sheet fed by the feed roller 48 to a second transfer roller 50. The second transfer roller 50 faces the backup roller 38 with the intermediate transfer belt 28 interposed therebetween. The second transfer roller 50 transfers images having been transferred from the photosensitive drums 18 onto the intermediate transfer belt 28 through first transfer onto the sheet having been transported through the sheet transport path 46 through second transfer. Fixing rollers 56 are provided downstream of the second transfer roller 50 with transport belts 54 disposed therebetween. The fixing rollers 56 fix the images onto the sheet onto which the images have been transferred through the second transfer by applying heat and pressure. The sheet onto which the images have been fixed by the fixing rollers 56 is output to the sheet output member 44.

Next, the meandering controller 40 is described in detail.

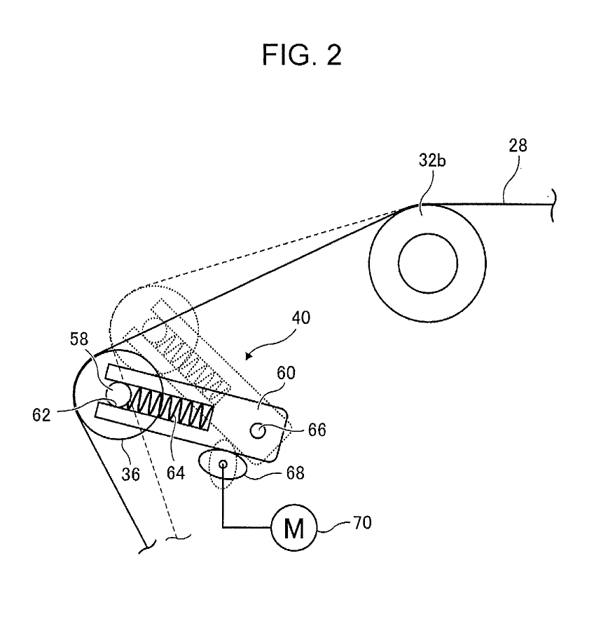

Referring to FIG. 2, the steering roller 36 includes a rotational shaft 58, about which the steering roller 36 is rotated. The rotational shaft 58 of the steering roller 36 is secured on a side corresponding to the back side of the page of FIG. 2 (referred to as “IN side” hereafter). The meandering controller 40 is provided in the steering roller 36 on a side corresponding to the front side of the page of FIG. 2 (referred to as “OUT” side hereafter).

The meandering controller 40 includes a rotating arm 60 that has a bearing 62 formed at a tip end thereof. The rotational shaft 58 of the steering roller 36 is rotatably supported by the bearing 62. Furthermore, a pressure spring 64 is disposed between the rotational shaft 58 and the rotating arm 60, thereby pressing the OUT side of the intermediate transfer belt 28 through the rotational shaft 58 interposed therebetween. The rotating arm 60 is supported by a support shaft 66 and in contact with a cam 68. The cam 68 is connected to a drive motor 70 and rotated by a drive force applied by the drive motor 70. When the cam 68 is rotated, the rotating arm 60 is rotated about the support shaft 66. This rotation of the rotating arm 60 moves the steering roller 36, for example, from a position indicated by a solid line to a position indicated by a dotted line. When the position of the OUT side of the steering roller 36 is changed, tension applied to the intermediate transfer belt 28 on the IN side and the OUT side is changed, thereby the posture of the intermediate transfer belt 28 is changed. This change in the posture of the intermediate transfer belt 28 changes the positions of the image forming units 12Y, 12M, 12C, and 12K relative to the photosensitive drums 18 in the axial direction. Thus, color misregistration between the photosensitive drums 18 is reduced.

The color misregistration is caused by a movement of the intermediate transfer belt 28 in the axial direction (occurrence of belt walk) due to the difference in the outer diameter between the rollers over which the intermediate transfer belt 28 is looped, the difference in the circumference of the intermediate transfer belt 28, or the like. Thus, when the belt walk is detected, the meandering controller 40 is operated so as to suppress the belt walk.

Next, the first transfer surface forming member 32a is described in detail.

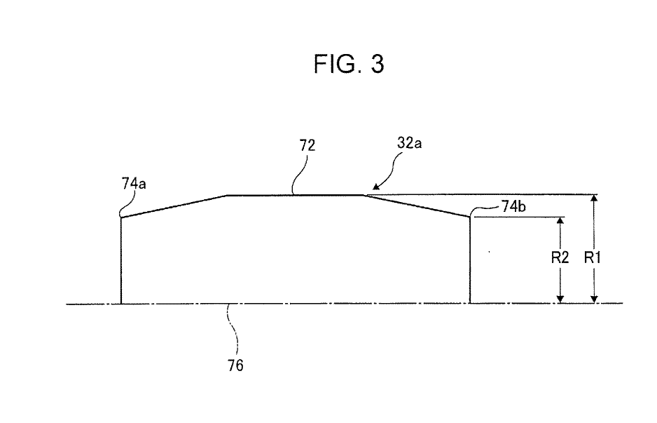

As illustrated in FIG. 3, the first transfer surface forming member 32a has a shape of a crowned roller. That is, an outer radius R1 of a central portion 72 of the first transfer surface forming member 32a in the axial direction (direction perpendicular to a movement direction of the intermediate transfer belt 28) is larger than an outer radius R2 of both end portions 74a and 74b.

R1 and R2 are preferably in the following relationship:

1.5%≦(R1−R2)/R1≦6.0% (1)

When (R1−R2)/R1 is less than 1.5%, no effect is obtained, and when (R1−R2)/R1 is more than 6.0%, running of the intermediate transfer belt 28 is affected.

According to the present exemplary embodiment, the central portion 72 is formed as a cylindrical surface parallel to a central axis 76, and a tapered inclined surface in which the radius gradually decreases from the central portion 72 toward the end portions 74a and 74b is interposed between the central portion 72 and both the end portions 74a and 74b.

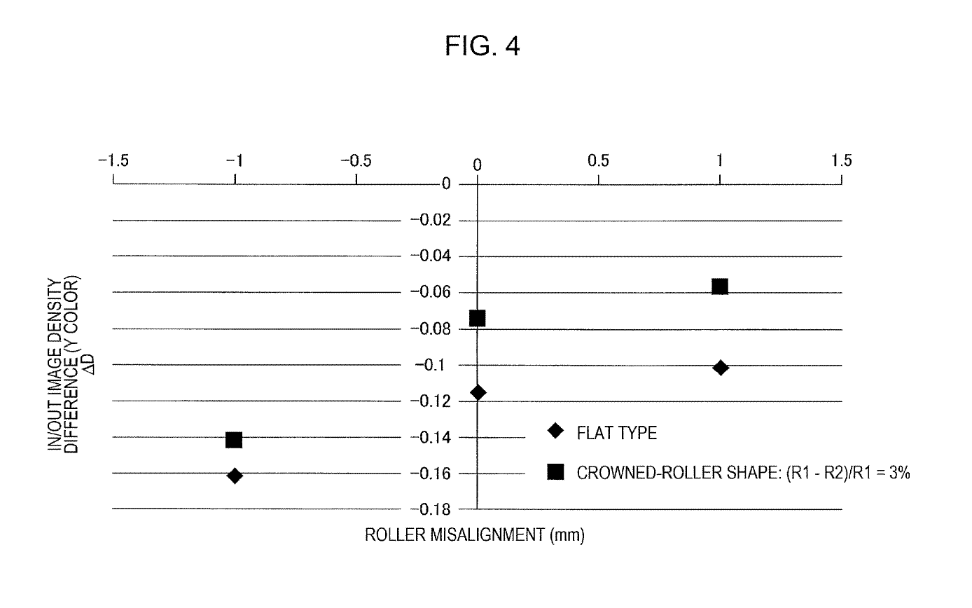

FIG. 4 illustrates how an image density difference varies between the IN and OUT sides with the first transfer surface forming member 32a having a flat shape and that having the crowned-roller shape. An image density difference ΔD in the Y color (Y color formed by the image forming unit 12Y closest to the first transfer surface forming member 32a) between the IN and OUT sides is obtained under the following conditions: that is, the crowned-roller shape is configured to satisfy the relationship (R1−R2)/R1=3%; and roller misalignment is changed to −1 mm, 0 mm, and 1 mm by the meandering controller 40. As a result, the image density difference ΔD is smaller with the first transfer surface forming member 32a having the crowned-roller shape than with the first transfer surface forming member 32a having the flat shape under any of the roller misalignment of −1 mm, 0 mm, and 1 mm. The effect obtained with the first transfer surface forming member 32a having the crowned-roller shape reduces in the order of Y, M, C, and K. When the other first transfer surface forming member 32b also has a crowned-roller shape, the image density difference ΔD may be further reduced. However, the magnitude of the effect obtained with the first transfer surface forming member 32b having the crowned-roller shape is not necessarily as large as that obtained with the first transfer surface forming member 32a having the crowned-roller shape.

The reason why the image density difference ΔD is able to be reduced by the first transfer surface forming member 32a having the crowned-roller shape is thought to be as follows.

That is, the intermediate transfer belt 28 stretched by the first transfer surface forming members 32a and 32b with a certain tension is urged by each of the first transfer rollers so as to be pressed against a corresponding one of the photosensitive drums 18. Thus, when there is a difference in the circumference of the intermediate transfer belt 28 between the IN side and the OUT side, there is a difference in the tensile force between the IN side and the OUT side in the intermediate transfer belt 28. Accordingly, there is a difference in the pressing force by which the intermediate transfer belt 28 is pressed against the photosensitive drum 18 between the IN side and the OUT side. This difference in the pressing force against the photosensitive drum 18 causes difference in the amount of transfer of toner held by the photosensitive drum 18 to the intermediate transfer belt 28. This may result in non-uniform density. Here, it is thought that, when the first transfer surface forming member 32a has the crowned-roller shape, the intermediate transfer belt 28 just having passed through the first transfer surface forming member 32a is subjected to a force that stretches the intermediate transfer belt 28 from an inner side to an outer side. This reduces the difference in the tensile force of the intermediate transfer belt 28 between the IN side and the OUT side, thereby reducing the difference in the pressing force against the photosensitive drum 18 between the IN side and the OUT side. By reducing the difference in the pressing force against the photosensitive drum 18 between the IN side and the OUT side as described above, the density difference ΔD between the IN side and the OUT side may be reduced.

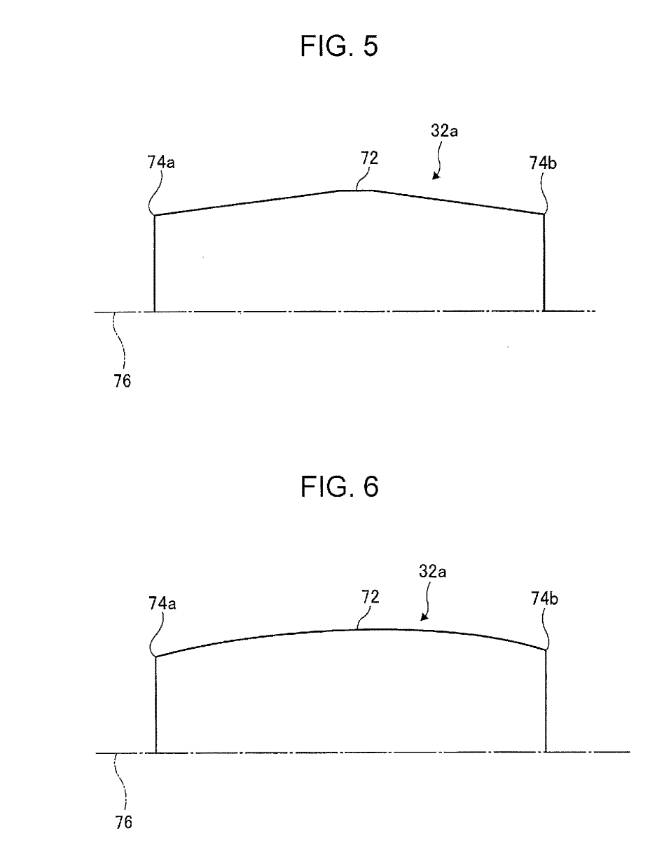

The crowned-roller shape of the first transfer surface forming member 32a is not limited to the shape illustrated in FIG. 3. For example, the first transfer surface forming member 32a may have a tapered shape as follows: that is, as illustrated in FIG. 5, only the central portion 72 have a large outer radius that gradually decreases from the central portion 72 toward both the ends 74a and 74b. Alternatively, as illustrated in FIG. 6, the radius of the first transfer surface forming member 32a may gradually decrease from the central portion 72 so as to form smooth curves.

The foregoing description of the exemplary embodiment of the present invention has been provided for the purposes of illustration and description. It is not intended to be exhaustive or to limit the invention to the precise forms disclosed. Obviously, many modifications and variations will be apparent to practitioners skilled in the art. The embodiment was chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

1. A transfer device comprising:
a belt-shaped body to which at least one image held by at least one image holding body is transferred and which is moved so as to be rotated in a single direction; and
a plurality of transfer surface forming members that form a transfer surface so as to cause the belt-shaped body to be in contact with the at least one image holding body,
wherein at least one of the plurality of transfer surface forming members is provided on each side of the at least one image holding body such that the at least one image holding body is disposed in a region between the plurality of transfer surface forming members, and
wherein at least one of the plurality of transfer surface forming members has an outer radius, that has a central portion and one and an other end portions in a direction perpendicular to a movement direction of the belt-shaped body, and the outer radius is larger at the central portion than at the one and the other end portions, the at least one of the plurality of transfer surface forming members having the outer radius that is larger at the central portion than at the one and the other end portions being disposed between the at least one image holding member and a drive member,
the drive member being disposed (i) outside of the region between the plurality of transfer surface forming members where the at least one image holding body is disposed and (ii) outside of the plurality of transfer surface forming members, and
a steering roller disposed (i) outside of the region between the plurality of transfer surface forming members where the at least one image holding body is disposed and (ii) outside of the plurality of transfer surface forming members.

2. The transfer device according to claim 1,
wherein the at least one of the plurality of transfer surface forming members having the outer radius larger at the central portion than at the one and the other end portions is adjacent to the at least one image holding body on an upstream side of the at least one image holding body in the movement direction of the belt-shaped body.

3. The transfer device according to claim 1, further comprising:
a plurality of transfer members arranged in the movement direction of the belt-shaped body,
wherein the at least one image includes a plurality of images,
wherein the at least one image holding body includes a plurality of image holding bodies,
wherein the plurality of transfer members transfer the plurality of images from the plurality of image holding bodies to the belt-shaped body, and
wherein a distance between one of the plurality of transfer members provided on a most upstream side in the movement direction of the belt-shaped body and one of the plurality of transfer surface forming members adjacent to the one of the transfer members is less than a distance by which the plurality of transfer members are spaced apart from one another.

4. The transfer device according to claim 2, further comprising:
a plurality of transfer members arranged in the movement direction of the belt-shaped body,
wherein the at least one image includes a plurality of images,
wherein the at least one image holding body includes a plurality of image holding bodies,
wherein the plurality of transfer members transfer the plurality of images from the plurality of image holding bodies to the belt-shaped body, and
wherein a distance between one of the plurality of transfer members provided on the most upstream side and one of the plurality of transfer surface forming members adjacent to the one of the transfer members is less than a distance by which the plurality of transfer members are spaced apart from one another.

5. The transfer device according to claim 1,
wherein in the at least one of the plurality of the transfer surface forming members having the outer radius that is larger at the central portion than at the one and the other end portions, a difference in the outer radius between the central portion and the one end portion and a difference in the outer radius between the central portion and the other end portion are from 1.5% to 6.0% of the outer radius at the central portion.

6. The transfer device according to claim 2,
wherein in the at least one of the plurality of transfer surface forming members having the outer radius that is larger at the central portion than at the one and the other end portions, a difference in the outer radius between the central portion and the one end portion and a difference in the outer radius between the central portion and the other end portion are from 1.5% to 6.0% of the outer radius at the central portion.

7. The transfer device according to claim 3,
wherein in the at least one of the plurality of transfer surface forming members having the outer radius that is larger at the central portion than at the one and the other end portions, a difference in the outer radius between the central portion and the one end portion and a difference in the outer radius between the central portion and the other end portion are from 1.5% to 6.0% of the outer radius at the central portion.

8. The transfer device according to claim 4,
wherein in the at least one of the plurality of transfer surface forming members having the outer radius that is larger at the central portion than at the one and the other end portions, a difference in the outer radius between the central portion and the one end portion and a difference in the outer radius between the central portion and the other end portion are from 1.5% to 6.0% of the outer radius at the central portion.

9. The transfer device according to claim 1, further comprising:
a meandering controller that controls meandering of the belt-shaped body.

10. The transfer device according to claim 2, further comprising:
a meandering controller that controls meandering of the belt-shaped body.

11. The transfer device according to claim 3, further comprising:
a meandering controller that controls meandering of the belt-shaped body.

12. The transfer device according to claim 4, further comprising:
a meandering controller that controls meandering of the belt-shaped body.

13. The transfer device according to claim 5, further comprising:
a meandering controller that controls meandering of the belt-shaped body.

14. The transfer device according to claim 6, further comprising:
a meandering controller that controls meandering of the belt-shaped body.

15. The transfer device according to claim 7, further comprising:
a meandering controller that controls meandering of the belt-shaped body.

16. The transfer device according to claim 8, further comprising:
a meandering controller that controls meandering of the belt-shaped body.

17. An image forming apparatus comprising:
an image holding body that holds an image;
a belt-shaped body to which the image held by the image holding body is transferred and which is moved in a single direction; and
a plurality of transfer surface forming members that form a transfer surface so as to cause the belt-shaped body to be in contact with the image holding body,
wherein at least one of the plurality of transfer surface forming members is provided on each side of the at least one image holding body such that the at least one image holding body is disposed in a region between the plurality of transfer surface forming members, and
wherein at least one of the plurality of transfer surface forming members has an outer radius, that has a central portion and one and an other end portions in a direction perpendicular to a movement direction of the belt-shaped body, and the outer radius is larger at the central portion than at the one and the other end portions, the at least one of the plurality of transfer surface forming members having the outer radius that is larger at the central portion than at the one and the other end portions being disposed between the at least one image holding member and a drive member,
the drive member being disposed (i) outside of the region between the plurality of transfer surface forming members where the at least one image holding body is disposed and (ii) outside of the plurality of transfer surface forming members, and
a steering roller disposed (i) outside of the region between the plurality of transfer surface forming members where the at least one image holding body is disposed and (ii) outside of the plurality of transfer surface forming members.
